(19) United States
(12) Patent Application Publication
(10) Pub. No.: US 2025/0351025 A1
(43) Pub. Date: Nov. 13, 2025

(54) USER PLANE NETWORK FUNCTION IDENTIFIER DURING SESSION HANDOVER

(71) Applicant: T-MOBILE INNOVATIONS LLC, Overland Park, KS (US)

(72) Inventors: Saravana Kumar VELUSAMY, Overland Park, KS (US); Rahul Rashmikant AMIN, Issaquah, WA (US)

(21) Appl. No.: 18/660,019

(22) Filed: May 9, 2024

(51) Int. Cl. H04W 36/00; H04W 48/18

(52) U.S. Cl. CPC H04W 36/0077; H04W 48/18

(57) ABSTRACT

The present disclosure is directed to systems and methods for improved protocol session handover. By providing the selecting NF with a user plane NF identifier associated with the first session, the selecting NF can select the user plane NF associated with the first session in establishing the second session, resulting in a more optimal network in the event of protocol session handover.

### SUMMARY

The present disclosure is directed, in part to managing handovers in a wireless communication network, substantially as shown and/or described in connection with at least one of the figures, and as set forth more completely in the claims.

According to various aspects of the technology, various network functions (NFs) may be involved in handing over a first session associated with a first radio access technology (i.e., protocol), such as 5G to a second session associated with a second protocol (e.g., 4G). Occasionally, a first session may be subject to weak signals, for example, and a session handover may be required to restore proper connectivity. Conventionally, during session handover, a selecting NF is unaware which user plane NF was in use during the first session, and may select a different user plane NF for the second session, causing data latency, maintenance inefficiencies, and increased costs. By providing the selecting NF with a user plane NF identifier identifying the user plane NF in use during the first session for use in the second session, data latency, maintenance inefficiencies, and increased costs may be avoided.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates a computing device for use with the present disclosure;

FIG. 2 illustrates a diagram of a network environment in which implementations of the present disclosure may be employed;

FIG. 3 illustrates a flow diagram of a method for protocol session handover for use with the present disclosure; and

FIG. 4 illustrates a flow diagram of a method for protocol session handover for use with the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, wireless telecommunications networks are comprised of a plurality of network functions (NFs) that may communicate with each other to provision a number of functions associated with the NFs. Users of wireless telecommunications networks frequently move between geographic locations (i.e., between different cells) which may affect the strength of a signal from a first base station associated with a first protocol (e.g., 5G base station (gNB), 5G protocol). In scenarios where the signal associated with the first base station is insufficient to support a first session with a user equipment (UE), a mobility NF, such as the access and mobility management function (AMF), may receive an indication from the first base station requiring handover of the first session to establish a second session with a second base station via a second protocol (e.g., 4G base station (eNB), 4G protocol). The resulting second session using the second protocol may then provide sufficient signals from the second base station to the UE. During this handover, a selecting NF, such as a serving gateway (SGW), selects a user plane NF, such as a user plane function (UPF), with which to establish the second session. The selecting NF may have a number of user plane NFs to choose from, and the selecting NF may randomly determine which user plane NF to choose to establish the second session. Further, the selecting NF does not know which user plane NF was already in use during the first session, and thus the selecting NF may select a user plane NF different from the existing user plane NF used in the first session. As a result, the user plane NF of the first session remains anchored to the new second session, creating a hop between the newly selected user plane NF and the existing user plane NF.

Conventionally, the handover between different protocols (e.g., 5G to 4G) will likely result in the selecting NF choosing a user plane NF different from the existing user plane NF established in the original first session. Occasionally, the selecting NF may, by chance, select the existing user plane NF in use during first session, however, this represents a small number of handovers. Due to the large possible number of user plane NFs within a given network environment, the selecting NF is unlikely to select the correct one. The deployment of two different user plane NFs during the second session causes capacity bottlenecks, requiring service providers to purchase additional capacity for user plane NFs. Service providers may face inefficiency in troubleshooting because of the need to explore two different user plane NFs as potential source of a problem. Further, users may experience delays and data latencies in the second session due to the hop between user plane NFs. A proactive solution to avoid the selection of mismatching user plane NFs in session handovers (e.g., 5G to 4G handovers) would reduce costs, latencies, and troubleshooting inefficiencies.

In contrast to conventional solutions and to facilitate a more optimized handover between different protocols, the present disclosure is directed to providing the selecting NF with a user plane NF identifier to allow the selecting NF to choose the user plane NF corresponding to the user plane NF identifier (i.e., the user plane NF in use during the first session). Such a solution would entirely avoid the frequent scenario in which two different user plane NFs are employed in the second session, thereby reducing or eliminating the need for service providers to purchase additional capacity for user plane NFs, reducing data latencies experienced by users, and reducing inefficiencies experienced in troubleshooting. This solution provides a proactive approach in facilitating a more efficient handover between different protocols (e.g., 5G to 4G handovers).

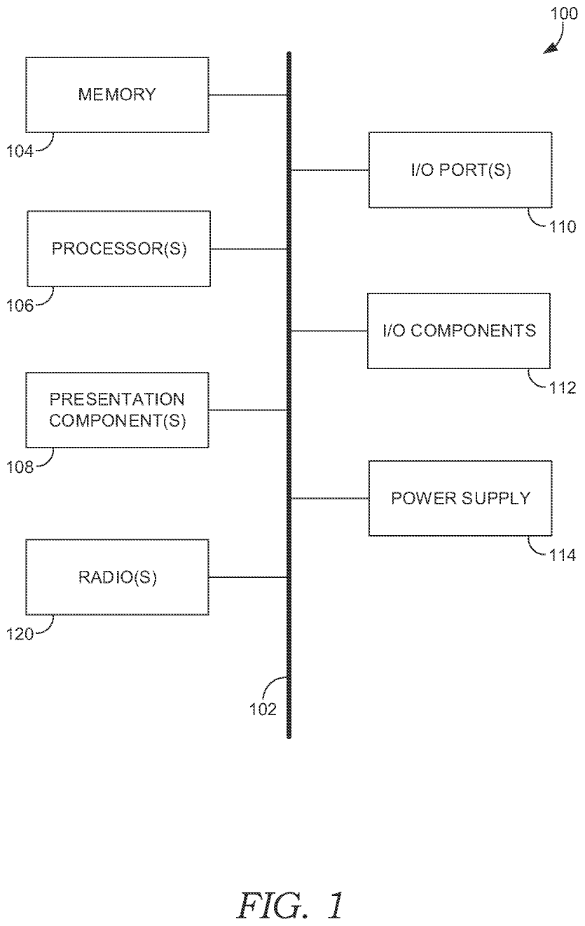

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VOLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

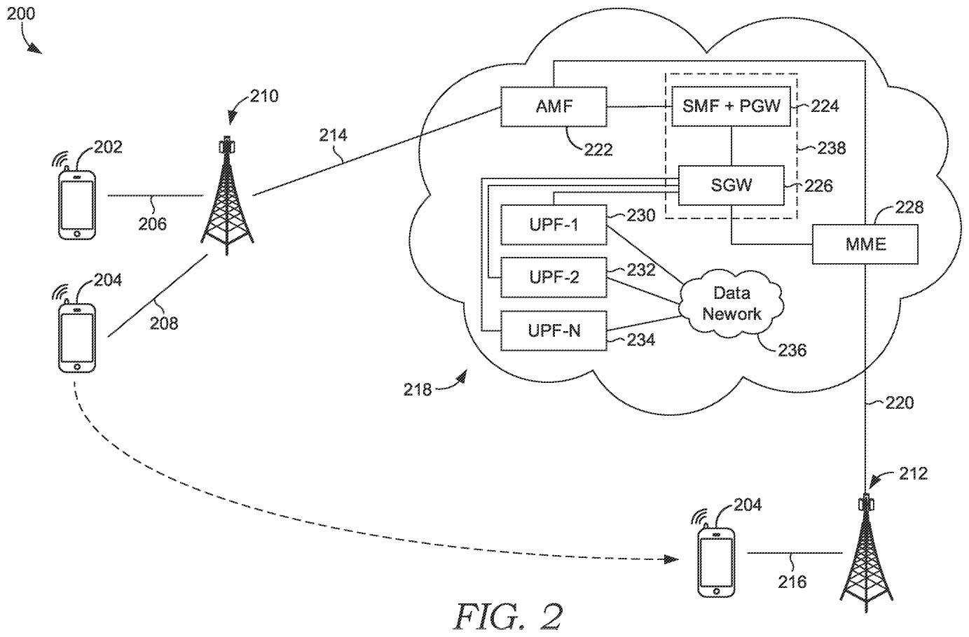

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as a first UE 202 and/or a second UE 204, one or more base stations, such as a first base station 210 and/or a second base station 212, and a core network 218, though in some implementations, it may not be necessary for certain features to be present. The network environment may include a number of routers, switches, and the like. The network environment 200 is generally configured for wirelessly connecting the first UE 202 and/or the second UE 204 to data or services that may be accessible on one or more application servers or other functions, nodes, or servers not pictured in FIG. 2 so as to not obscure the focus on the present disclosure.

The network environment 200 comprises one or more of the first UE 202 and the second UE 204. Though network environment 200 is illustrated with both the first UE 202 and the second UE 204, one skilled in the art will appreciate that fewer or more UEs may be present in any particular network environment. The first UE 202 and the second UE 204 are illustrated generally, and may take any number of forms, including a tablet, phone, or wearable device, or any other device discussed with respect to FIG. 1 and may have any one or more components or features of the computing device 100 of FIG. 1. In some aspects, the first UE 202 and/or the second UE 204 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like). The first UE 202 and/or the second UE 204 may be compatible with to two or more wireless communication networks associated with two or more wireless communication protocols (e.g., 5G, 4G, 3G).

The network environment 200 comprises one or more of the first base station 210 and/or the second base station 212 to which the first UE 202 and/or the second UE 204 may potentially connect to (also referred to as ‘camping on,’ ‘attaching,’ in the industry). Though network environment 200 is illustrated with both the first base station 210 and the second base station 212, one skilled in the art will appreciate that additional base stations may be present in any particular network environment. Each of the first base station 210 and the second base station 212 of the network environment 200 is configured to wirelessly communicate with UEs, such as the first UE 202 and/or the second UE 204 using any wireless telecommunication protocol desired by a network operator, including but not limited to 3G, 4G, 5G, 6G, 802.11x and the like. In aspects, the first base station 210 uses a first protocol (e.g., 5G) to wirelessly communicate with UEs and the second base station 212 uses a second protocol RAT (e.g., 4G) to wirelessly communicate with UEs. In aspects, the first base station 210 is a gNB associated with 5G protocols and the second base station 212 is an eNB associated with 4G protocols.

The first base station 210 is configured to transmit and receive one or more of a first signal 206 and/or a second signal 208 between the first base station 210 and the first UE 202 and/or between the first base station 210 and the second UE 204. The first signal 206 and the second signal 208 may each be configured according to the first protocol associated with the first base station 210. The one or more of the first signal 206 and the second signal 208 comprise one or more uplink signals for which the first base station 210 is configured to receive from the first UE 202 and/or second UE 204. The one or more of the first signal 206 and/or the second signal 208 may also comprise downlink signals for which the first base station 210 is configured to receive from the first UE 202 and/or the second UE 204. In response to receiving certain requests from the first UE 202 and/or the second UE 204, the first base station 210 may communicate with the core network 218 via a first backhaul 214. The first backhaul 214 may be configured according to the first protocol associated with the first base station 210. For example, in order for the first UE 202 to connect to a desired network service (e.g., PSTN call, voice over LTE (VOLTE) call, voice over new radio (VoNR), data, or the like), the first UE 202 may communicate an attach request to the first base station 210, which may, in response, communicate a registration request to the core network 218 via the first backhaul 214.

Occasionally, for example when a UE moves geographic locations, the signals associated with a base station associated with the first protocol (e.g., the first base station 210) may become too weak to support sufficient connectivity. A geographically closer base station associated with the second protocol (e.g., the second base station 212) may be better suited to provide connectivity and results in a handover from a first protocol to a second protocol (e.g., 5G to 4G handovers). For example, the second UE 204 may move geographic locations (as illustrated by the dotted line in FIG. 2) such that the second signal 208 is too weak to support a connection with the first base station 210 associated with the first protocol. In such examples, the second UE 204 may connect to the second base station 212 via a third signal 216 configured according to the second protocol associated with the second base station 212. In these examples, a first session with the first base station 210 using the first protocol must be handed over to the second base station 212 associated with the second protocol, often requiring communication between various network components within the core network 218.

The second base station 212 is configured to transmit and receive one or more of a third signal 216 between the second base station 212 and a UE (e.g., the first UE 202 and/or second UE 204). The third signal 216 may be configured according to the second protocol associated with the second base station 212. The third signal 216 may comprise one or more uplink signals for which the second base station 212 is configured to receive from the UE (e.g., the first UE 202 and/or second UE 204). The third signal 216 may also comprise downlink signals for which the second base station 212 is configured to receive from the UE, (e.g., the first UE 202 and/or the second UE 204). In response to receiving certain requests from the UE (e.g., the first UE 202 and/or second UE 204), the second base station 212 may communicate with the core network 218 via a second backhaul 220. The second backhaul 220 may be configured according to the second protocol associated with the second base station 212.

Relevant to the present disclosure, one or more network functions (NFs) of the core network 218 may communicate messages to other NFs within the core network 218 to facilitate a handover between the first protocol associated with the first base station 210 and the second protocol associated with the second base station 212. As used herein, the term “network function” is used to describe a computer processing module and/or one or more computer executable services being executed on one or more computing processing modules. For example, the core network 218 may comprise NFs that include any one or more of an access and mobility management function (AMF) 222, a session management function (SMF) coupled to a packet gateway (PGW) 224, a serving gateway (SGW) 226, a mobility management entity (MME) 228, one or more user plane functions (UPFs) 230, 232, 234, and a data network 236. Notably, the preceding nomenclature is used with respect to the 3GPP 4G and 5G architecture; in other aspects each of the preceding NFs may take different forms, including consolidated or distributed forms that perform the same general operations. In other architectures or protocols, the NFs may be given other names, however, the NFs herein refer to functions, not specifically identified components. Though the AMF 222, SMF+PGW 224, SGW 226, MME 228, UPFs 230, 232, 234, and the data network 236 are illustrated in the core network 218, the core network 218 may have more or fewer NFs than shown. Further, though the AMF 222, SMF+PGW 224, SGW 226, MME 228, UPFs 230, 232, 234, and the data network 236 are illustrated as disposed within the core network 218 it is expressly contemplated that the location in the network environment 200 is non-limiting. For example, the NFs described above may be disposed between the first base station 210 and/or the second base station 212 and the core network 218 (i.e., the network edge) or may be isolated as stand-alone components, or a combination of these.

The core network 218 may include NFs as defined by their function. The AMF 222, for example, is generally responsible for managing registration and mobility of UEs, such as the first UE 202 and/or the second UE 204, and achieves this by coordinating signaling between UEs, such as the first UE 202 and/or the second UE 204, and other NFs. The SMF+PGW 224, for example, is generally responsible for interworking between different protocols, such as facilitating handovers between 5G to 4G. The SGW 226, for example, is generally responsible for managing sessions during handovers between protocols, such as by selecting the UPF with which to establish a second session with. Together, the SMF+PGW 224 and the SGW 226 are referred to as a converged core 238, which generally aids handover between protocols. The MME 228, for example, is generally responsible for managing mobility, sessions, authentication, and network policies of UEs, such as the first UE 202 and/or the second UE 204. The UPFs 230, 232, 234, for example, are generally responsible for providing data paths from UEs, such as the first UE 202 and/or the second UE 204, to a data network, such as the data network 236. In any particular network environment 200, there may be numerous UPFs, such as UPF1 230, UPF2 232 and beyond, such that there are N-number of UPFs, represented as UPFN 234. The data network 236 may be responsible for routing data packets between different network components, such as between UEs (e.g., the first UE 202 and/or the second UE 204) and external networks like the internet.

Various NFs may communicate with each other to facilitate handover between the first session using the first protocol to the second session using the second protocol. In the first session, for example, a user plane NF, such as UPF1 230, may already be in use. When an indication that a handover is required is received by a first mobility NF (e.g., the AMF 222), the first mobility NF may communicate with other NFs to instruct a selecting NF (e.g., the SGW 226) to establish the second session using the second protocol with the second base station 212. The selecting NF may then select a user plane NF (e.g., the UPFs 230, 232, 234) with which to establish the second session. Conventionally, the selecting NF is unaware which user plane NF is in use during the first session, and as a result, may select a user plane NF that is different from the existing user plane NF in use during the first session (e.g., UPF2 232). Upon this occurrence, capacity bottlenecks, data latencies, and inefficiency in troubleshooting results.

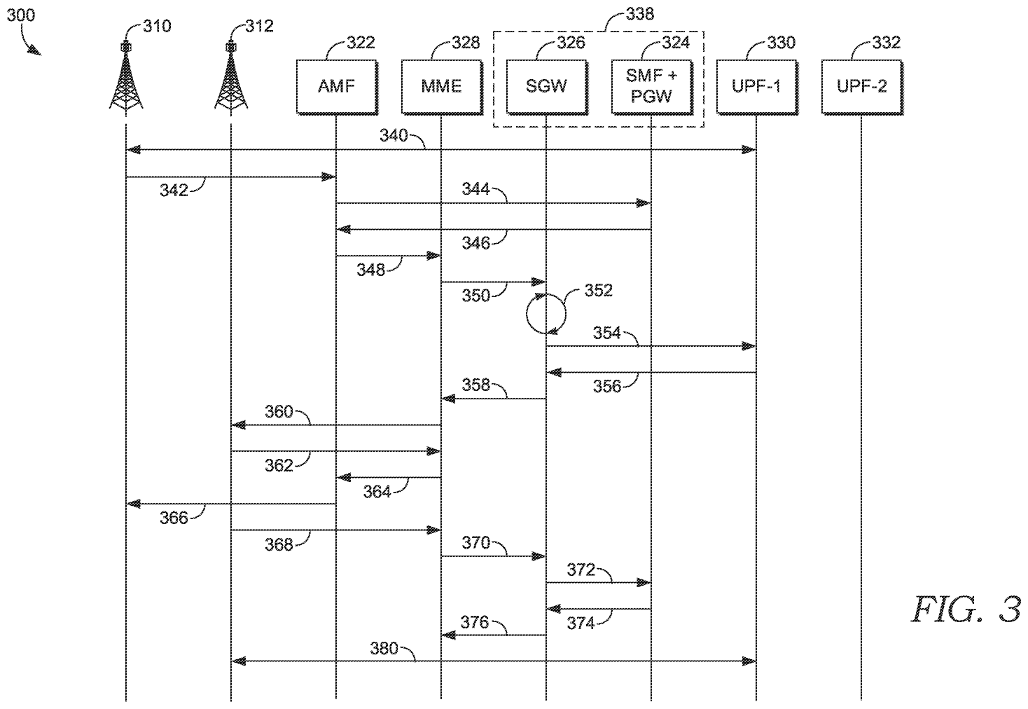

Turning now to FIG. 3, a call flow diagram is illustrated in accordance with one or more aspects of the present disclosure. A call flow 300 may be said to exist between one or more NFs discussed in greater detail herein and is not meant to exhaustively show every interaction that would be necessary to practice the invention, so as not to obscure the present disclosure, but is instead meant to illustrate one or more potential interactions between NFs. The call flow 300 may be relevantly said to include a first base station 310 (e.g., the first base station 210 of FIG. 2), a second base station 312 (e.g., the second base station 212 of FIG. 2), an AMF 322 (e.g., the AMF 222 of FIG. 2), an MME 328 (e.g., the MME 228 of FIG. 2), an SGW 326 (e.g., the SGW 226 of FIG. 2), an SMF+PGW (e.g., the SMF+PGW 224 of FIG. 2), a UPF1 330 (e.g., UPF1 230 of FIG. 2), and a UPF2 332 (e.g., UPF2 232 of FIG. 2). Together, the SMF+PGW 324 and the SGW 326 may be considered a converged core 338 (e.g., the converged core 238 of FIG. 2). Notably, the preceding nomenclature is used with respect to the 3GPP 4G and 5G architecture; in other aspects, each of the preceding NF components may take different forms, including consolidated or distributed forms that perform the same general operations.

The call flow 300 represents a scenario where a UE (e.g., the first UE 202 and/or the second UE 204 of FIG. 2) may initially have a first session using a first protocol with a first base station 310 (e.g., the first base station 210 of FIG. 2). Upon an indication that handover is required (e.g., weak signals from the first base station), the first session using the first protocol with the first base station 310 may be handed over to a second session using a second protocol with a second base station 312 (e.g., the second base station 212 of FIG. 2). In some embodiments, the first base station 310 is a gNB, the first protocol is 5G, the second base station 312 is an eNB, and the second protocol is 4G. In other embodiments, the first base station 310 is configured to a first protocol, the second base station 312 is configured to a second protocol different from the first protocol, and the first protocol and the second protocol may be any number of potential protocols (e.g., 3G, 2G, Wi-Fi).

In a first step 340, the first session is established using the first protocol between the first base station 310 and the UPF1 330. In some embodiments, the first session is established in 5G protocol, and the first base station 310 is a gNB. In a second step 342, the AMF 322 receives an indication that handover is required between the first session in the first protocol and the second session using the second protocol (e.g., the AMF 322 receiving a “Handover Required” message from the first base station 310). In some embodiments, this may be the result of a UE (e.g., the first UE 202 and/or the second UE 204) moving in geographic location such that the first signal associated with the first session is too weak to support a sufficient connection using the first protocol. However, for example, the second base station 312 may be available to provide the second session due to a stronger signal with the UE (e.g., the first UE 202 and/or the second UE 204). In other embodiments, session handover may be the result of load balancing of the network associated with the first session, disrupted service associated with the first base station 310, and/or device compatibility issues associated with a UE's connection to the first base station 310.

Relevant to the present disclosure, and in a third step 344, the AMF 322 requests first session information associated with the first session using the first protocol from the SMF+PGW 324 (e.g., the AMF 322 communicating an “nsmf-pdusession/sm-context/imsi/retrieve” message to the SMF+PGW 324). Under conventional solutions, the SMF+PGW 324, when responding to the AMF 322, would not include any identifying information associated with the existing UPF in use during the first session using the first protocol. In a fourth step 346, the SMF+PGW 324 communicates, in response to the request from the AMF 322, first session information including a user plane NF identifier identifying the existing UPF in use during the first session using the first protocol (i.e., UPF1 330 in call flow 300), such that the AMF 322 obtains the user plane NF identifier. For example, the SMF+PGW 324 responds to the AMF 322 by sending a “200 OK nsmf-pdusession/sm-context/imsi/retrieve” response, the response including the user plane NF identifier. While the call flow 300 indicates UPF1 330 is the UPF associated with the user plane NF identifier, another UPF (e.g., UPF2 332 or others not shown) may instead be associated with the user plane NF identifier. The AMF 322 receives the first session information including the user plane NF identifier.

The user plane NF identifier may be communicated within messages between NFs by including the user plane NF identifier within an information element of a message. A single message (e.g., request, response) may include numerous information elements representing various types of data being communicated between NFs. The information element may be defined by one or more various protocols (e.g., Diameter, GTP, NGAP, SIAP). The data type (e.g., label), length, and/or possible values of the information element (i.e., parameters of the information element) may be defined by one or more of the various protocols. The user plane NF identifier may be entered in a suitable format into the information element based on the parameters of the information element. The user plane NF identifier may be exchanged between NFs in various types of messages which include the information element. For example, the user plane NF identifier could be sent in both a “200 OK nsmf-pdusession/sm-context/ismi/response” message as well as a “forward relocation request” message. The content of the information element including the user plane NF identifier may be converted from a first format to a second format, the second format reflecting the identity of the user plane NF in use during the first session using the first protocol.

At a fifth step 348, the AMF 322 communicates a request to create the second session using the second protocol to the MME 328 including the user plane NF identifier (e.g., the AMF 322 communicating a “Forward Relocation Request” message including the user plane NF identifier to the MME 328). At a sixth step 350, the MME 328 communicates a request to create the second session using the second protocol, the request including the user plane NF identifier to the SGW 326 (e.g., the MME 328 communicating a “Create Session Request” message including the user plane NF identifier to the SGW 326). At a seventh step 352, the SGW 326 employs logic to determine which UPF (e.g., UPF1 330, UPF 332) to create the second session with, based on the user plane NF identifier communicated by the MME 328 in the sixth step 350. This may involve the SGW 326 converting the content of the information element from the first format to the second format, the second format reflecting the identity of the user plane NF in use during the first session using the first protocol.

At an eighth step 354, the SGW 326 communicates a session establishment request to the UPF (e.g., UPF1 330, UPF2 332) associated with the user plane NF identifier (e.g., the SGW 326 communicating an “SXa_SESSION_ESTABLISHMENT_REQUEST” to the UPF associated with the user plane NF identifier). Although the call flow 300 illustrates two UPFs (e.g., UPF1 330, UPF2 332), the call flow 300 may involve numerous UPFs such that the SGW 326 has numerous potential UPFs to establish the second session with. At a ninth step 356, the SGW 326 receives a session establishment response from the UPF associated with the user plane NF identifier (i.e., UPF1 330 in this call flow 300) (e.g., the SGW 326 receiving an “SXa_SESSION_ESTABLISHMENT_RESPONSE” from the UPF associated with the user plane NF identifier).

At a tenth step 358, the SGW 326 communicates a confirmatory response to the MME 328 in response to the message sent by the MME 328 in the sixth step 350 (e.g., the SGW 326 communicating a “Create Session Response” message to the MME 328). At an eleventh step 360, the MME 328 communicates a request to handover the first session using the first protocol to the second session using the second protocol to the second base station 312 (e.g., the MME 328 communicating a “Handover Request” message to the second base station 312). In response, and at a twelfth step 362, the second base station 312 communicates a message in response to the MME 328 (e.g., the second base station 312 communicating a “Handover Request Acknowledge” message to the MME 328).

At a thirteenth step 364, the MME 328 communicates a response to the message sent by the AMF 322 in the fifth step 348 (e.g., the MME 328 communicating a “Forward Relocation Response” message to the AMF 322). At a fourteenth step 366, the AMF 322 communicates a command to the first base station 310 commanding handover of the first session using the first protocol to the second base station 312 via the second session using the second protocol (e.g., the AMF 322 communicating a “Handover Command” message to the first base station 310). At this point in the call flow 300, the UE associated with the first session with the first base station 310 using the first protocol (e.g., the first UE 202 and/or the second UE 204 of FIG. 2) may receive a handover message from the first base station 310 and in response, may send a handover message to the second base station 312.

At a fifteenth step 368, the second base station 312 communicates a notification message to the MME 328 notifying the MME 328 that a handover has been initiated and/or is occurring (e.g., the second base station 312 communicating a “Handover Notify” message to the MME 328). At a sixteenth step 370, the MME 328 communicates with the SGW 326 (e.g., the MME 328 communicating a “Modify Bearer Request” to the SGW 326). At a seventeenth step 372, the SGW 326 communicates a message to the SMF+PGW 324, (e.g., the SGW 326 communicating a “Modify Bearer Request” to the SMF+PGW 324). At an eighteenth step 374, the SMF+PGW 324 responds to the communication from the SGW 326 sent in the seventeenth step 372 (e.g., the SMF+PGW 324 communicating a “Modify Bearer Response” message to the SGW 326). At a nineteenth step 376, the SGW 326 sends a communication to the MME 328 (e.g., the SGW 326 communicating a “Modify Bearer Response” message to the MME 328). At a twentieth step 380, the second session using the second protocol is established between the second base station 312 and the UPF associated with the user plane NF identifier (i.e., UPF1 330 in this call flow 300), preventing the second session using the second protocol from being associated with more than one UPF.

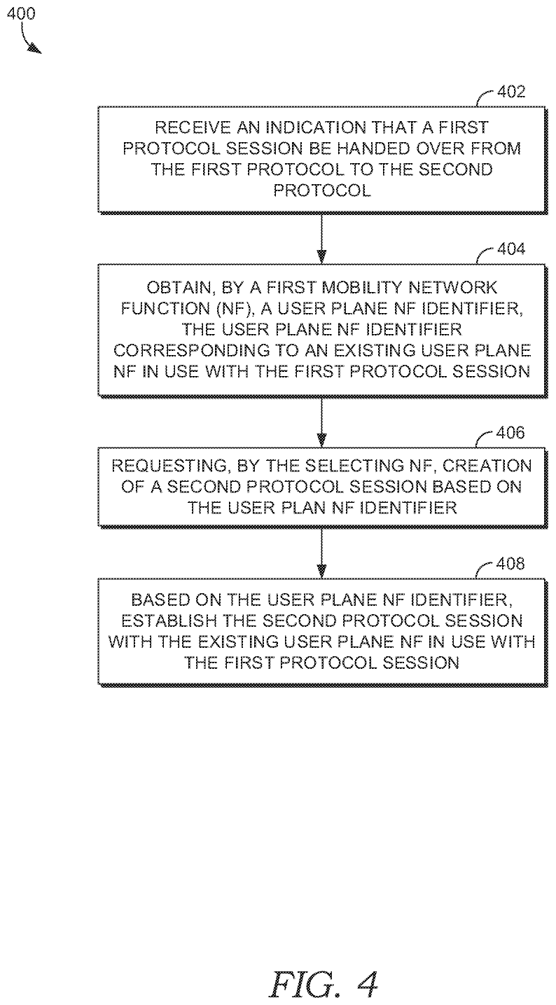

While references to FIG. 3 included specific NF names used in the 4G and 5G networks, it is expressly contemplated that NFs may take different forms, including consolidated or distributed forms that perform the same general operations. In other architectures or protocols, the NFs may be given other names, however, the NFs herein refer to functions, not specifically identified components. Though the AMF 322, SMF+PGW 324, SGW 326, MME 328, and UPFs 330, 332 are illustrated in the call flow 300, the call flow 300 may have additional, alternative, or fewer NFs than shown. Turning to FIG. 4, NFs are given functional names, and the NFs may include one or more of the NFs discussed with respect to FIG. 3.

Turning now to FIG. 4, a flow chart is provided that illustrates one or more aspects of the present disclosure relating to a method 400 for session handover between a first protocol and a second protocol (e.g., 5G to 4G handover). In a first step 402, a first mobility NF receives an indication that a first protocol session (i.e., a first session associated with a first protocol) should be handed over from the first protocol session to a second protocol session (i.e., a second session associated with a second protocol). In some embodiments, the first mobility NF may be an AMF (e.g., AMF 222 of FIG. 2 and/or the AMF 322 of FIG. 3). In some aspects, the first mobility NF may receive the indication that handover is required via a communication from a first base station associated with the first protocol session (e.g., the first base station 210 of FIG. 2 and/or the first base station 310 of FIG. 3). In some embodiments, the first base station is a gNB, and the first protocol is 5G. Handover may be indicated due to a weak signal between a UE associated with the first session (e.g., the first UE 202 and/or the second UE 204 of FIG. 2), geographic location changes of the UE associated with the first session, load balancing of the network associated with the first session, disrupted service associated with the first base station, and/or device compatibility issues associated with a UEs connection to the first base station.

At a second step 404, the first mobility NF obtains a user plane NF identifier. In some aspects, the first mobility NF may receive the user plane NF identifier in response to a message sent by the first mobility NF requesting the first session information from an informing NF. The user plane NF identifier may be sent within an information element in a communication or message from an informing NF to the first mobility NF. The informing NF may receive and/or retain information identifying the user plane NF in use during the first protocol session. In some embodiments, the informing NF may communicate the user plane NF identifier corresponding to the existing user plane NF in use during the first protocol session in response to a communication from the first mobility NF. In these embodiments, the communication from the first mobility NF may be a request for first session information (e.g., the user plane NF identifier) associated with the first protocol session. In some aspects, the informing NF is an SMF+PGW (e.g., the SMF+PGW 224 of FIG. 2 and/or the SMF+PGW 324 of FIG. 3). The user plane NF identifier may correspond to an existing user plane NF in use during first protocol session. In some aspects, the user plane NF may be a UPF (e.g., UPF1 230, UPF2 232, UPFN 234 of FIG. 2 and/or UPF1 330, UPF 323 of FIG. 3), and in other aspects, the user plane NF may be a PGW-U and/or SGW-U.

At a third step 406, a selecting NF requests creation of the second protocol session with the user plane NF associated with the user plane NF identifier. In some aspects, the selecting NF receives the user plane NF identifier within an information element in a communication and/or message from a second mobility NF. In these aspects, the second mobility NF is associated with the second base station (e.g., the second base station 212 of FIG. 2 and/or the second base station 312 of FIG. 3). In some embodiments, the second mobility NF is an MME (e.g., MME 228 of FIG. 2 and/or MME 328 of FIG. 3). In some aspects, the selecting NF is a SGW (e.g., the SGW 226 of FIG. 2 and/or the SGW 326 of FIG. 3). In some embodiments, requesting creation of the second protocol session involves the selecting NF communicating a session establishment request to the user plane NF associated with the user plane NF identifier. In these embodiments, the user plane NF may respond with a session establishment response to the selecting NF.

At a fourth step 408, the second protocol session is established with the existing user plane NF in use with the first protocol session, based on the user plane NF identifier. In some aspects, establishing the second protocol session involves various NFs and base stations, which may communicate and receive a variety of messages to and from other NFs and base stations. For example, the first mobility NF may send a communication commanding handover to the first base station (e.g., the first base station 210 of FIG. 2 and/or the first base station 310 of FIG. 3). Further, for example, the second base station (e.g., the second base station 212 of FIG. 2 and/or the second base station 312 of FIG. 3) may send a notification message notifying the second mobility NF that handover is occurring. In some embodiments, the second protocol session is established between the second base station, which is receiving signals from a UE (e.g., the first UE 202 and/or the second UE 204), and the user plane NF associated with the user plane NF identifier.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for session handover between a first protocol to a second protocol, the system comprising:
one or more computer processing components configured to execute operations comprising:
receiving an indication that a first protocol session be handed over from the first protocol to the second protocol;
obtaining, by a first mobility network function (NF), a user plane NF identifier, the user plane NF identifier corresponding to an existing user plane NF in use with the first protocol session;
requesting, by a selecting NF, creation of a second protocol session with the existing user plane NF based on the user plane NF identifier; and
based on the user plane NF identifier, establishing the second protocol session with the existing user plane NF in use with the first protocol session.

2. The system of claim 1, wherein the first mobility NF is an access and mobility management function (AMF).

3. The system of claim 1, wherein the selecting NF is a serving gateway (SGW).

4. The system of claim 1, wherein the first protocol is 5G and the second protocol is 4G.

5. The system of claim 1, wherein the existing user plane NF is a user plane function (UPF).

6. The system of claim 1, wherein obtaining comprises requesting, by the first mobility NF, session information including the user plane NF identifier, from an informing NF and receiving, by the first mobility NF, the user plane NF identifier.

7. The system of claim 6, wherein the first mobility NF is an AMF and wherein the informing NF is a session management function (SMF) coupled to a packet gateway (PGW).

8. The system of claim 1, wherein requesting creation of the second protocol session further comprises communicating, by the selecting NF, an establishment request requesting establishment of the second protocol session with the existing user plane NF, to the existing user plane NF.

9. The system of claim 8, wherein requesting creation of the second protocol session further comprises receiving, by the selecting NF, an establishment response from the existing user plane NF.

10. A method for session handover between a first protocol and a second protocol, the method comprising:
receiving an indication that a first protocol session be handed over from the first protocol to the second protocol;
obtaining, by a first mobility network function (NF), a user plane NF identifier, the user plane NF identifier corresponding to an existing user plane NF in use with the first protocol session;
requesting, by a selecting NF, creation of a second protocol session with the existing user plane NF based on the user plane NF identifier; and
based on the user plane NF identifier, establishing the second protocol session with the existing user plane NF in use with the first protocol session.

11. The method of claim 10, wherein the first mobility NF is an access and mobility management function (AMF).

12. The method of claim 11, wherein the selecting NF is a serving gateway (SGW).

13. The method of claim 12, wherein the first protocol is 5G and the second protocol is 4G.

14. The method of claim 13, wherein the existing user plane NF is a user plane function (UPF).

15. The method of claim 14, wherein obtaining comprises requesting, by the first mobility NF, session information including the user plane NF identifier, from an informing NF and receiving, by the first mobility NF, the user plane NF identifier.

16. The method of claim 15, wherein the informing NF is a session management function (SMF) coupled to a packet gateway (PGW).

17. The method of claim 16, wherein requesting creation of the second protocol session further comprises communicating, by the selecting NF, an establishment request requesting establishment of the second protocol session with the existing user plane NF, to the existing user plane NF.

18. The method of claim 17, wherein requesting creation of the second protocol session further comprises receiving, by the selecting NF, an establishment response from the existing user plane NF.

19. A non-transitory computer readable media having instructions stored thereon that, when executed by one or more computer processing components, cause the one or more computer processing components to perform a method for session handover between a first protocol and a second protocol, the method comprising:
receiving an indication that a first protocol session be handed over from the first protocol to the second protocol;
obtaining, by a first mobility network function (NF), a user plane NF identifier, the user plane NF identifier corresponding to an existing user plane NF in use with the first protocol session;
requesting, by a selecting NF, creation of a second protocol session with the existing user plane NF based on the user plane NF identifier; and
based on the user plane NF identifier, establishing the second protocol session with the existing user plane NF in use with the first protocol session.

20. The non-transitory computer readable media of claim 19, wherein the first mobility NF is an access and mobility function (AMF), wherein the selecting NF is a serving gateway (SGW), wherein the existing user plane NF is a user plane function (UPF), and wherein the first protocol is 5G and the second protocol is 4G.
